(19) United States
(12) Patent Application Publication
(10) Pub. No.: US 2017/0198820 A1
(43) Pub. Date: Jul. 13, 2017

(54) Switching Structure for a Faucet

(71) Applicant: Shong I Copper Co., Ltd., Chang Hua Hsien (TW)

(72) Inventor: Chin-Tang Chung, Chang Hua Hsien (TW)

(21) Appl. No.: 14/989,949

(22) Filed: Jan. 7, 2016

(51) Int. Cl. F16K 11/065; E03C 1/04

(52) U.S. Cl. CPC F16K 11/0655; E03C 1/0404

(57) ABSTRACT

A switching structure for a faucet contains: a body and a switch valve. The body includes an accommodation groove for accommodating a control valve, a first outlet tube, and a second outlet tube. The accommodation groove has at least one drain hole, and the first outlet tube has a first outlet, a valve chamber and a water flow space. The second outlet tube has a second outlet. Between the water flow space and the at least one drain hole is defined a first water channel, and the water flow space has a first through orifice. The switch valve includes a holder, a controlling post, a closing member, and a resilient element. The closing member has a water stopping portion and a first locking portion which are formed on one side of the closing member facing to an aperture, and the first outlet tube has a second locking portion.

### BACKGROUND OF THE INVENTION

Field of the Invention

The present invention relates to a faucet, and more particularly to a switching structure for the faucet.

Description of the Prior Art

Conventional faucets contain a single outlet and two outlets respectively, wherein a conventional faucet with the single outlet is fixed on a water sink or other places. Another faucet with the two outlets is mounted on a water supply device (such as a shower head or a shower).

Referring to FIGS. 15 and 16, a conventional faucet with two outlets contains a body 30 and a switch valve 40. The body 30 includes an accommodation groove 31, a first outlet tube 32, and a second outlet tube 33. The accommodation groove 31 is configured to accommodate a control valve 34, the first outlet tube 32 has a first outlet 321 for flowing water, and the second outlet tube 33 includes a second outlet 331 for connecting with a water supply device (such as a shower head or a shower). The first outlet tube 32 has a first channel 332, a second channel 323, and a third channel 324. The first channel 332 communicates with an opening of the control valve 34 in the accommodation groove 31, between the first channel 322 and the second channel 323 is defined a first through hole 325, between the first channel 322 and the third channel 324 is defined a second through hole 326, the second channel 323 is in communication with the first outlet 321 of the first outlet tube 32, and the third channel 324 communicates with the second outlet 331 of the second outlet tube 33. The switch valve 40 is fixed on the first outlet tube 32 of the body 30 and corresponds to the first through hole 325 and the second through hole 326. The switch valve 40 includes a controlling post 41, an upper end of which extends out of the first outlet tube 32 of the body 30 and connects with a pull lever 42, and a lower end of the controlling post 41 couples with a stop pad 43 and is located between the first through hole 325 and the second through hole 326 of the first outlet tube 32 of the body 30, and a spring 44 fits on the controlling post 41 and pushes the stop pad 43 to move toward the second through hole 326.

As turning off the conventional faucet, the stop pad 43 of the switch valve 40 is pushed by the spring 44 to move toward the second through hole 326 so that the stop pad 43 abuts against the second through hole 326. When the control valve 34 turns on water supply, the water flows out of the first outlet 321 via the first channel 322, the first through hole 325 and the second channel 323 from the control valve 34. As desiring to flow the water out of the second outlet 331, the pull lever 42 is pulled to push the controlling post 41 so that the stop pad 43 of the controlling post 41 closes the first through hole 325, and the second through hole 326 is turned on, hence the water flows out of the second outlet 331 from the control valve 34 through the first channel 322, the second through hole 326, and the third channel 324, and the controlling post 41 does not fall downwardly since the stop pad 43 is pushed by water pressure, when the control valve 34 closes the water supply, the water pressure disappears or the pull lever 42 is pressed so that the controlling post 41 recovers original state.

However, an elasticity of the spring 44 of the control valve 40 has to be calculated exactly so that when the water flows out of the first outlet 321, the spring 44 pushes the stop pad 43 toward the second through hole 326, and when the water flows out of the second outlet 331, the elasticity of the spring 44 is less than a push force for pushing the stop pad 43 to move upwardly so as to avoid the stop pad 43 being pushed by the spring 44 to fall into the second through hole 326, such that when the control valve 40 operates, the controlling post 41 cannot slide smoothly because of poor quality and elasticity fatigue of the spring 44, water pressure or scales. Therefore, the controlling post 40 cannot be switched normally, and the water leaks out of the first outlet 321 or the second outlet 331 to cause using inconvenience.

The present invention has arisen to mitigate and/or obviate the afore-described disadvantages.

### SUMMARY OF THE INVENTION

The primary objective of the present invention is to provide a switching structure for a faucet which flows water out of a second outlet, and a closing member closes an aperture, the closing member is pushed toward the aperture by water pressure, such that a water stopping portion of the closing member closes the aperture, and the closing member or the water stopping portion contacts with a first locking portion and a second locking portion of the aperture so that the closing member closes the aperture to avoid a switch valve being influenced by a resilient element, the water pressure or scales. Accordingly, the resilient element fits on a controlling post easily, and the water does not leak out of a first outlet or a second outlet.

To obtain above-mentioned objectives, a switching structure for a faucet provided by the present invention contains: a body and a switch valve.

The body includes an accommodation groove, a first outlet tube, and a second outlet tube, the accommodation groove is configured to accommodate a control valve and has at least one drain hole defined on a bottom thereof, the first outlet tube has a first outlet and a valve chamber, and the second outlet tube has a second outlet, wherein the first outlet tube has a water flow space communicating with the first outlet and the valve chamber, between the water flow space and the at least one drain hole is defined a first water channel, the water flow space communicates with the second outlet, and the water flow space has a first through orifice formed therein and corresponding to the first water channel.

The switch valve is mounted in the valve chamber of the first outlet tube and includes a holder, a controlling post, a closing member, and a resilient element, wherein the holder is covered on the valve chamber, the controlling post is slidably inserted into the holder, a first end of the controlling post extends out of the holder, and a second end of the controlling post inserts into the valve chamber, the closing member is movably in the controlling post and extends out of one end of the valve chamber, the closing member has a water stopping portion and a first locking portion which are formed on one side of the closing member facing to an aperture of the first outlet tube, and the first outlet tube has a second locking portion arranged around a peripheral side of the aperture of the first outlet tube and corresponding to the first locking portion, and the resilient element pushes the controlling post to move outwardly.

### BRIEF DESCRIPTION OF THE DRAWINGS

FIG. 1 is a perspective view showing the assembly of a switching structure for a faucet in accordance with a preferred embodiment of the present invention.

FIG. 2 is a perspective view showing the exploded components of the switching structure for the faucet in accordance with the preferred embodiment of the present invention.

FIG. 3 is a cross sectional view showing the assembly of the switching structure for the faucet in accordance with the preferred embodiment of the present invention.

FIG. 4 is a cross sectional view showing the operation of the switching structure for the faucet in accordance with the preferred embodiment of the present invention.

FIG. 5 is an amplified cross-sectional view of a portion A of FIG. 4.

FIG. 6 is another cross sectional view showing the operation of the switching structure for the faucet in accordance with the preferred embodiment of the present invention.

FIG. 7 is an amplified cross-sectional view of a portion B of FIG. 6.

FIG. 8 is a cross sectional view showing the assembly of a switching structure for a faucet in accordance with another preferred embodiment of the present invention.

FIG. 9 is a cross sectional view showing the operation of the switching structure for the faucet in accordance with said another preferred embodiment of the present invention.

FIG. 10 is an amplified cross-sectional view of a portion C of FIG. 9.

FIG. 11 is another cross sectional view showing the operation of the switching structure for the faucet in accordance with said another preferred embodiment of the present invention.

FIG. 12 is an amplified cross-sectional view of a portion D of FIG. 11.

FIG. 13 is an amplified cross sectional view of a part of the operation of a switching structure for a faucet in accordance with another preferred embodiment of the present invention.

FIG. 14 is another amplified cross sectional view of a part of the operation of the switching structure for the faucet in accordance with another preferred embodiment of the present invention.

FIG. 15 is a cross sectional view showing the operation of a conventional switching structure for a faucet.

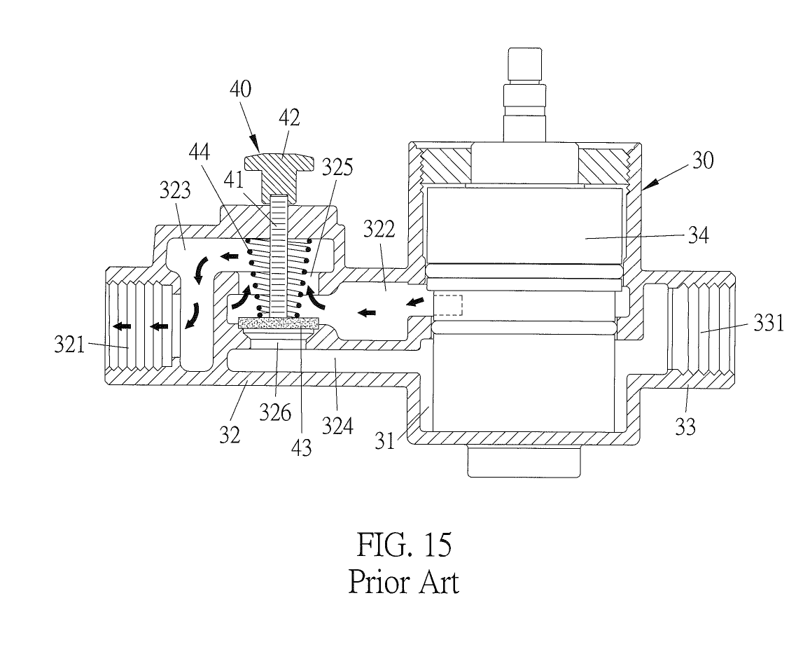

FIG. 16 is another cross sectional view showing the operation of the conventional switching structure for the faucet.

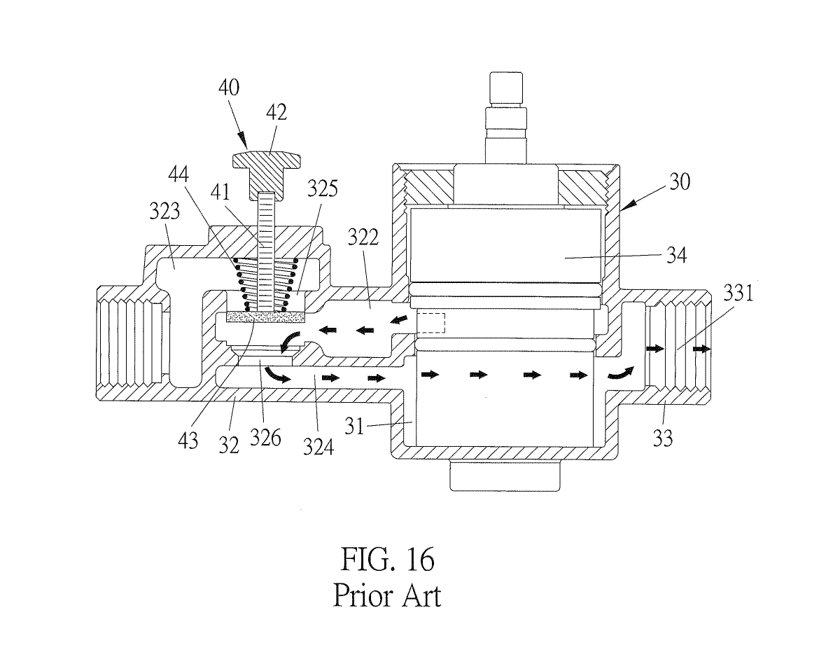

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

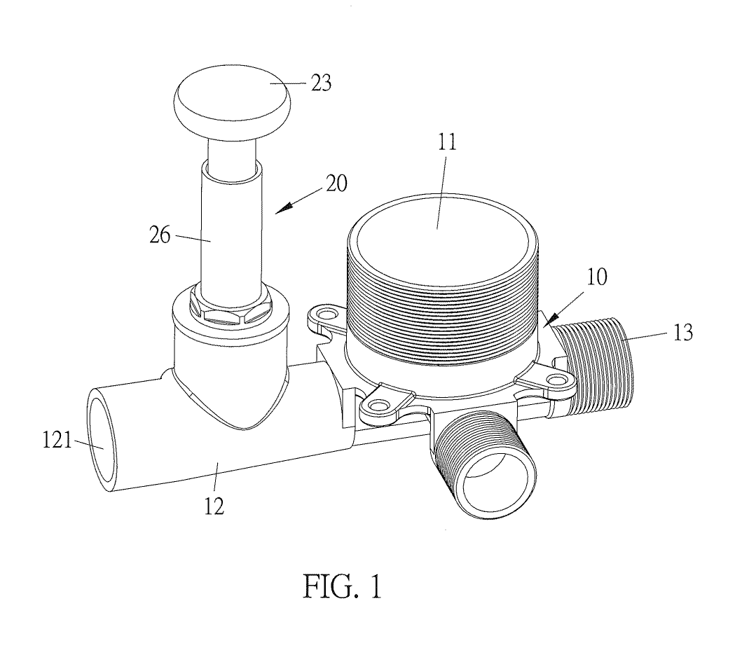

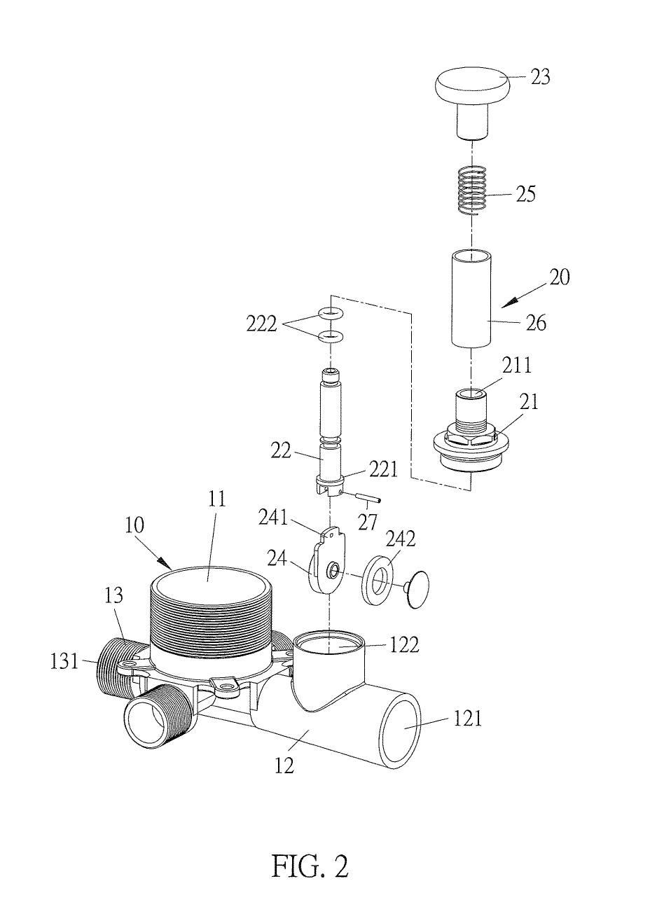

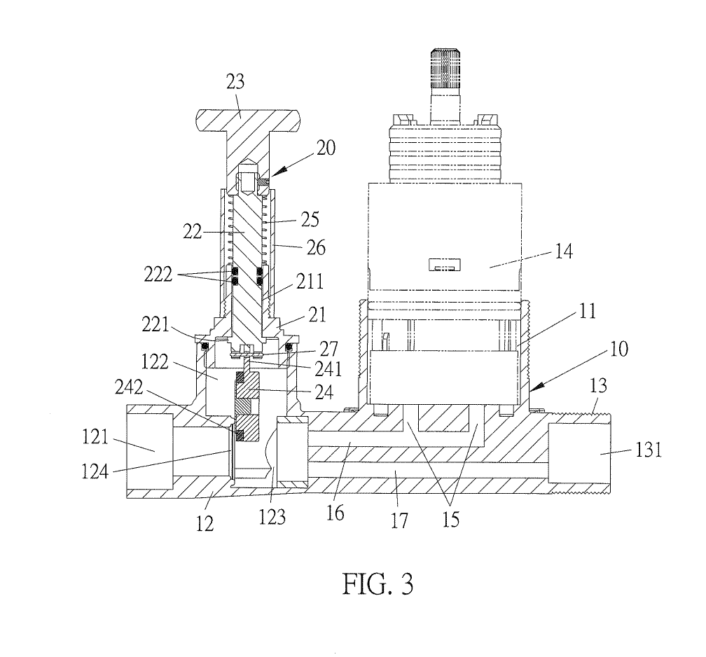

Referring to FIGS. 1-3, a switching structure for a faucet according to a preferred embodiment of the present invention comprises: a body 10 and a switch valve 20.

The body 10 includes an accommodation groove 11, a first outlet tube 12, and a second outlet tube 13. The accommodation groove 11 is configured to accommodate a control valve 14 and has at least one drain hole 15 (two drain holes 15 are provided in this embodiment) defined on a bottom of accommodation groove 11 thereof, the first outlet tube 12 has a first outlet 121 and a valve chamber 122, and the second outlet tube 13 has a second outlet 131 connect with a water supply device (such as a shower head or a shower) above the body 10, wherein the first outlet tube 12 has a water flow space 123 communicating with the first outlet 121 and the valve chamber 122, between the water flow space 123 and the at least one drain hole 15 is defined a first water channel 16, between the water flow space 123 and the second outlet 131 is defined a second water channel 17, and the water flow space 123 has a first through orifice 124 formed therein and corresponding to the first water channel 16.

The switch valve 20 is mounted in the valve chamber 122 of the first outlet tube 12 and includes a holder 21, a controlling post 22, a button 23, a closing member 24, a resilient element 25, and a fitting sleeve 26. The holder 21 is covered on the valve chamber 122 and has a second through orifice 211. The controlling post 22 is slidably inserted into the second orifice 211 of the holder 21, a first end of the controlling post 22 extends out of the holder 21, and a second end of the controlling post 22 inserts into the valve chamber 122, wherein the controlling post 22 has a protrusion 221 formed on the second end thereof and housed in the valve chamber 122, and the controlling post 22 has at least one stop ring 222 (there are two stop rings 222 provided in this embodiment) fitted on a middle section thereof and abutting against the an inner wall of the second through orifice 211 of the holder 21. The button 23 is fixed in the controlling post 22 and extends out of one end of the holder 21. The closing member 24 is movably in the controlling post 22 and extends out of one end of the valve chamber 122, and a shaft 27 inserts through a tab 241 of the closing member 24 and connects with the controlling post 22 and the valve chamber 122 so that the closing member 24 is connected with the controlling post 22. The closing member 24 horizontally moves or swings at a predetermined angle, and the closing member 24 has a water stopping portion 242 and a first locking portion A1 which are formed on one side of the closing member 24 facing to an aperture 124 of the first outlet tube 12, and the first outlet tube 12 has a second locking portion A2 arranged around a peripheral side of the aperture 124 of the first outlet tube 12 and corresponding to the first locking portion A1, wherein the first locking portion A1 is formed on the one side of the closing member 24, and the second locking portion A2 is arranged around the peripheral side of the aperture 124 and is formed in a ring shape, the first locking portion A1 fits with the second locking portion A2, and between the first locking portion A1 and the second locking portion A2 is defined a guiding means, and the guiding means is an arcuate surface or a tilted surface. The resilient element 25 (in this embodiment, the resilient element 25 is a spring) fits on the controlling post 22 so that the controlling post 22 is pushed by the resilient element 25 to move toward the button 23, wherein the fitting sleeve 26 is coupled with the holder 21 and is fitted on the controlling post 22 and the resilient element 25, thus covering the controlling post 22 and the resilient element 25.

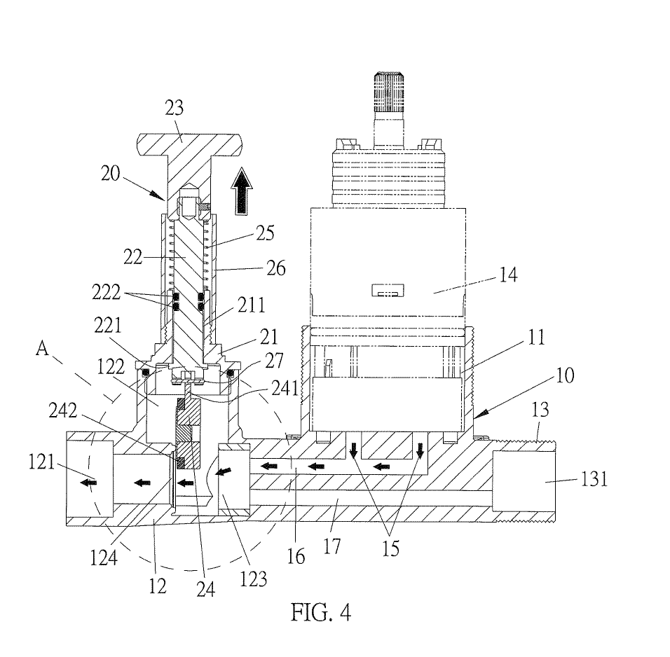

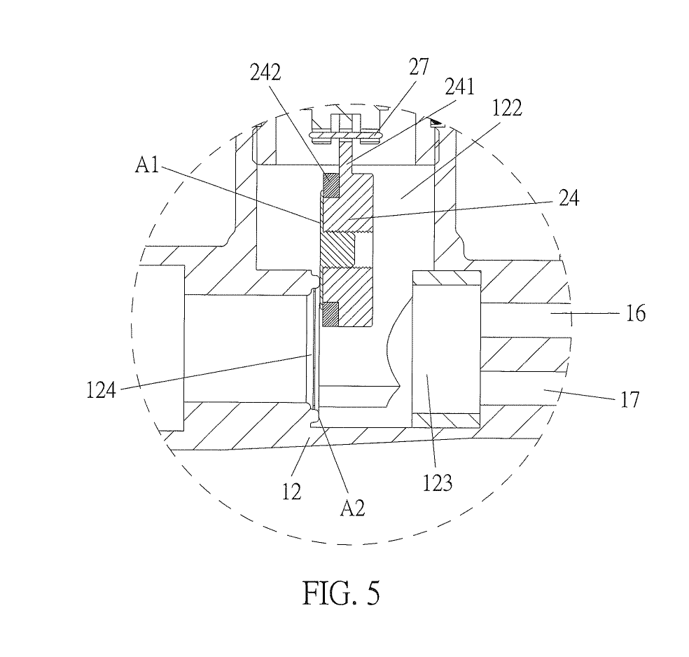

As closing the faucet, as shown in FIGS. 4 and 5, the controlling post 22 of the switch valve 20 is pushed by the resilient element 25 to move toward the button 23 so that the closing member 24 does not close the aperture 124, such that when the control valve 14 is turned on to flow the water, the water flows to the water flow space 123 via the at least one drain hole 15 and the first water channel 16, and the second outlet 131 couples with the water supply device above the body 10, hence the water flows out of the first outlet 121 through the aperture 124.

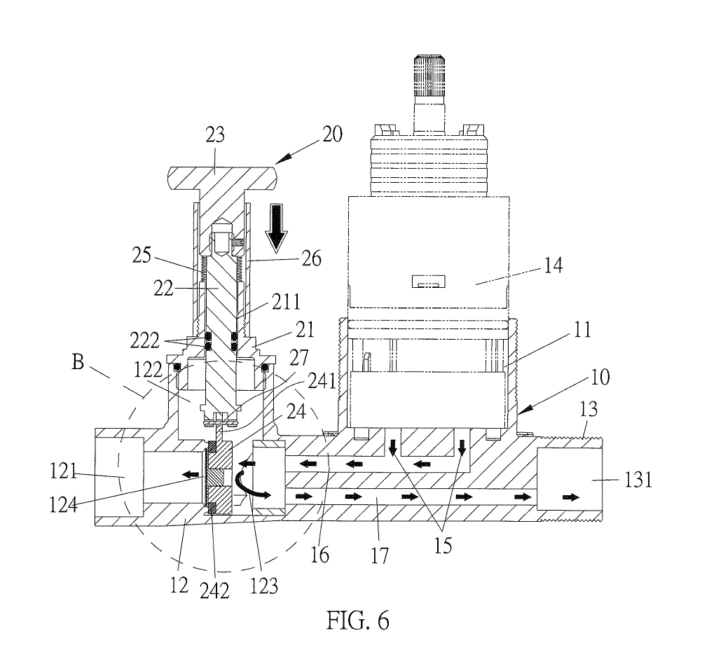

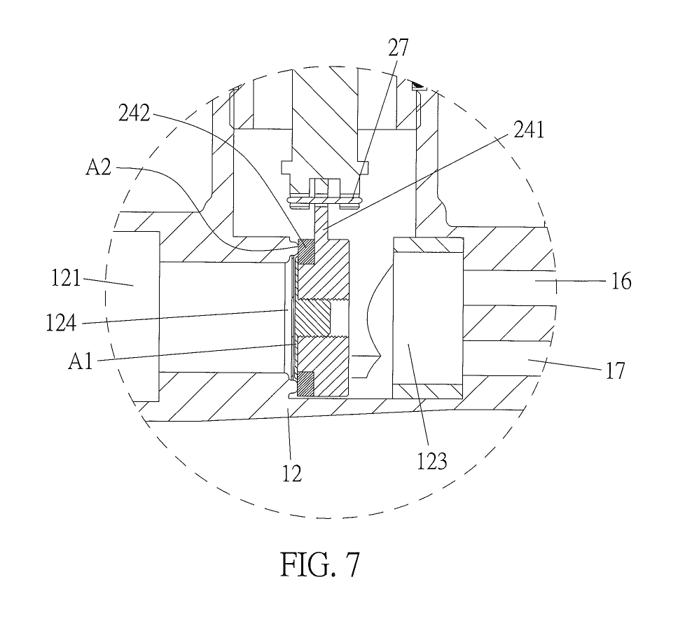

As desiring to flow the water out of the second outlet 131, as illustrated in FIGS. 6 and 7, the button 23 is pressed to force the controlling post 22 to slide toward the water flow space 123, such that the closing member 24 is driven to move toward the aperture 124, and the water is controlled by the control valve 14 to flow toward the water flow space 123 via the at least one drain hole 15 and the first water channel 16, hence a water pressure in the water flow space 123 pushes the closing member 24 toward the aperture 124 so that the water stopping portion 242 of the closing member 24 contacts with the aperture 124, and the first locking portion A1 of the closing member 24 engages with the second locking portion A2 of the aperture 124 of the first outlet tube 12, hence the closing member 242 closes the aperture 124 stably, and the water pressure forces the water to flow out of the second outlet 131 through the second water channel 17.

When the control valve 14 stops the water, the closing member 24 is not pushed by the water pressure and does not move toward the aperture 124, the controlling post 22 is pushed by the resilient element 25 to move toward the button 23, and the controlling post 22 and the closing member 24 move toward the button 23 by using the guiding means between the first locking portion A1 and the second locking portion A2, and the closing member 24 does not close the aperture 124.

When the water flows out of the second outlet 131, the button 23 is pulled by a user's pull force greater than engaging force of the first locking portion A1 and the second locking portion A2, the controlling post 22 and the closing member 24 move toward the button 23 by way of the guiding means between the first locking portion A1 and the second locking portion A2, and the closing member 24 does not close the aperture 124, hence the water flows out of the first outlet 121 through the aperture 124.

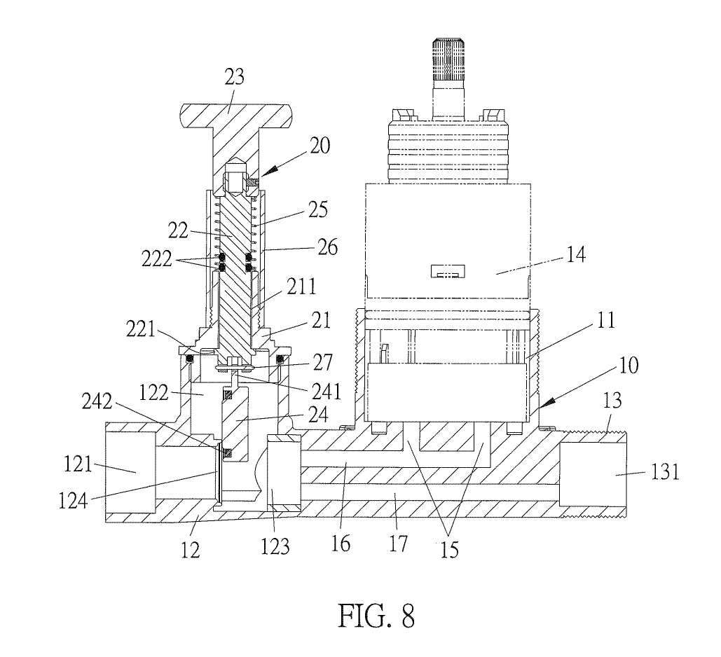

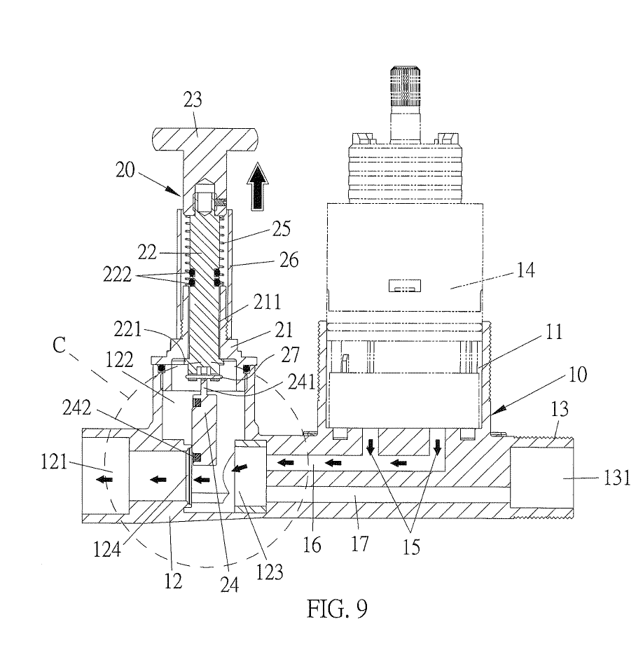

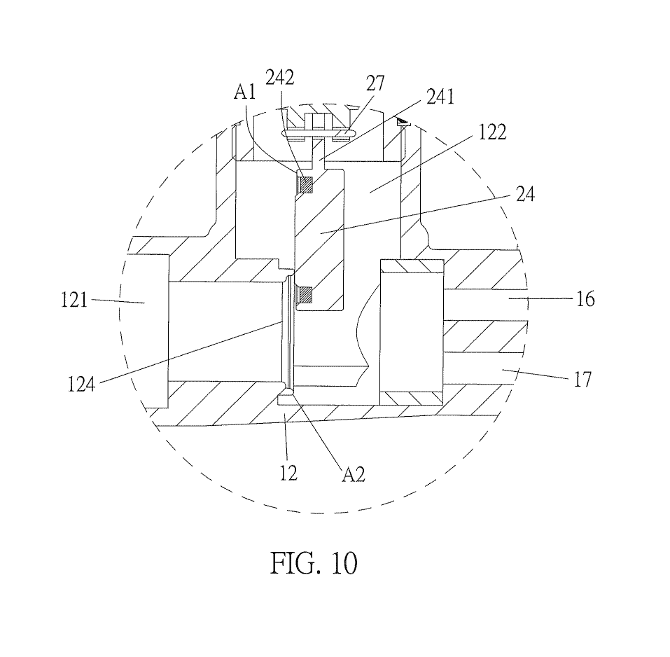

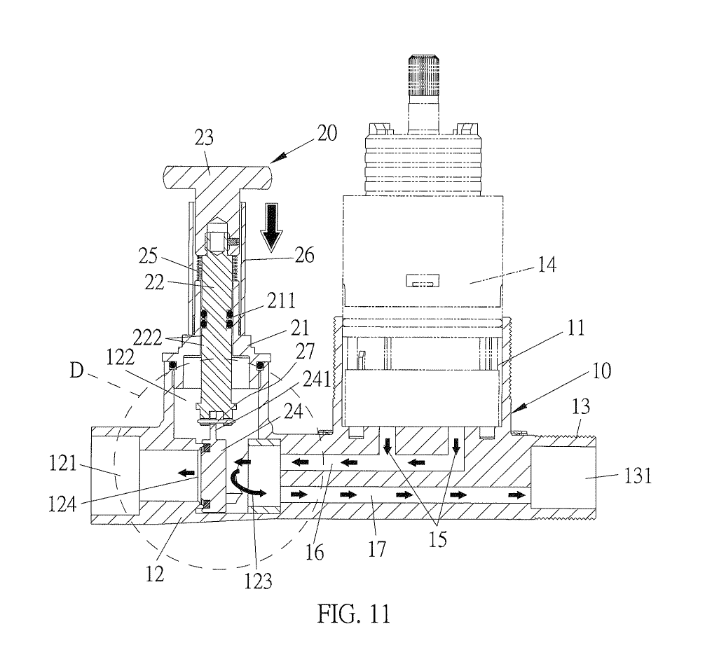

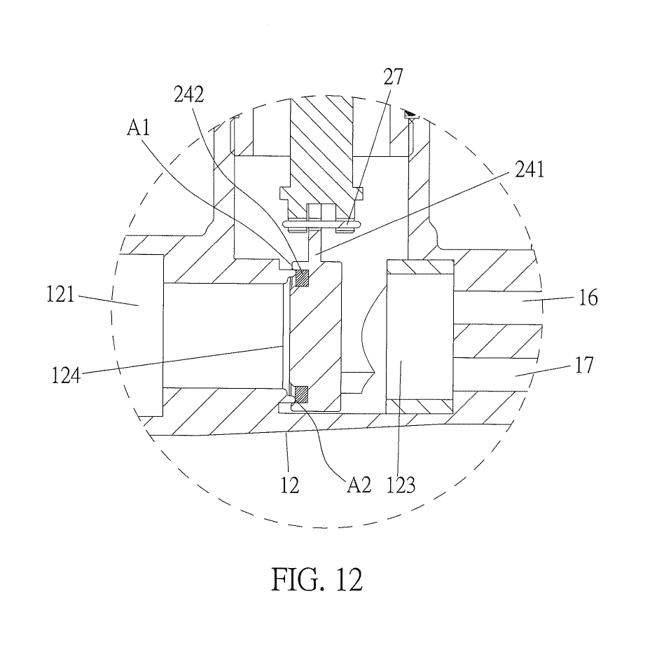

In another embodiment, the first locking portion A1 has a fitting projection configured to fit with the second locking portion A2, as shown in FIGS. 8 to 12, and between the first locking portion A1 and the second locking portion A2 is defined a guiding means.

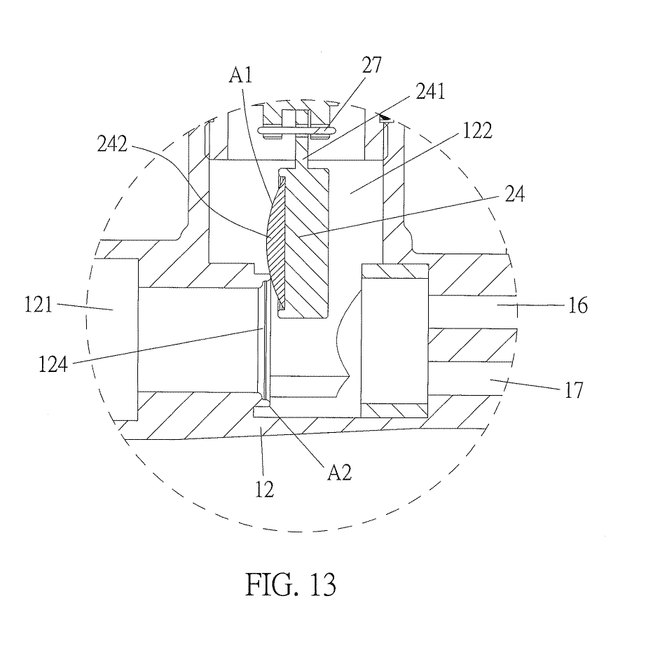

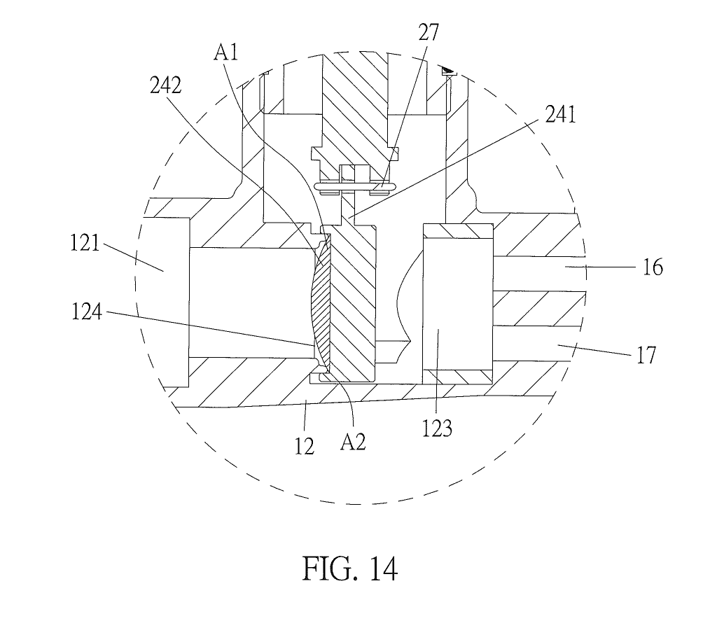

Referring to FIGS. 13 and 14, the first locking portion A1 is arranged on the water stopping portion 242 on the one side of the closing member 24 facing the aperture 124, and the second locking portion A2 is formed on the peripheral side of the aperture 124 and in a ring shape, such that the first locking portion A1 fits with an edge, an inner wall or an outer wall of the second locking portion A2, and between the first locking portion A1 and the second locking portion A2 is defined a guiding means.

Thereby, the switching structure of the present invention contains advantages as follows:

The water normally flows out of the first outlet 121, and the control valve is switched to control the water to flow out of the second outlet 131, wherein the button 23 is pressed to force the controlling post 22 to move toward the water flow space 123, the closing member 24 closes the aperture 124, and the water pressure in the water flow space 123 pushes the closing member 24 to move toward the aperture 124, and the water stopping portion 242 of the closing member 24 closes the aperture 124, the closing member 24 or the water stopping portion 242 engages with the first locking portion A1 of the aperture 124 and the second locking portion A2 of the first outlet tube 12, such that the closing member 24 closes the aperture 124 to avoid the switch valve 20 being influenced by the resilient element 25, the water pressure or scales. Accordingly, the resilient element 25 fits on the controlling post 22 easily, and the water does not leak out of the first outlet 121 or the second outlet 131.

While we have shown and described various embodiments in accordance with the present invention, it is clear to those skilled in the art that further embodiments may be made without departing from the scope of the present invention.

1. (canceled)

2. The switching structure for the faucet as claimed in claim 3, wherein between the water flow space and the second outlet is defined a second water channel.

3. The switching structure for the faucet as claimed in claim 9, wherein the controlling post of the switch valve has at least one stop ring fitted on a middle section thereof intermediate the protrusion and the button.

4. A switching structure for a faucet comprising:
a body including an accommodation groove, a first outlet tube, and a second outlet tube, with the accommodation groove configured to accommodate a control valve and having at least one drain hole defined on a bottom thereof, with the first outlet tube having a first outlet and a valve chamber, with the second outlet tube having a second outlet, wherein the first outlet tube has a water flow space communicating with the first outlet and the valve chamber, wherein between the water flow space and the at least one drain hole is defined a first water channel, wherein the water flow space communicates with the second outlet, and wherein the water flow space has a first through orifice formed therein and corresponding to the first water channel;
a switch valve mounted in the valve chamber of the first outlet tube and including a holder, a controlling post, a closing member, and a resilient element, wherein the holder covers the valve chamber, wherein the controlling post is slidably inserted into the holder, wherein a first end of the controlling post extends out of the holder, wherein a second end of the controlling post inserts into the valve chamber, wherein the closing member is movably mounted on the controlling post and extends in the valve chamber, wherein the closing member has a water stopping portion and a first locking portion which are formed on one side of the closing member facing an aperture of the first outlet tube, wherein the first outlet tube has a second locking portion arranged around a peripheral side of the aperture of the first outlet tube and corresponding to the first locking portion, wherein the resilient element pushes the controlling post to move outwardly, wherein the controlling post of the switch valve has a protrusion formed on the second end thereof and housed in the valve chamber, wherein the resilient member biases the controlling part to abut the protrusion with the holder; and
a shaft inserts through a tab of the closing member and connects with the controlling post and the valve chamber so that the closing member is connected with the controlling post with the protrusion located intermediate the shaft and the resilient member;
wherein the closing member does not close the aperture by using the resilient element, such that water flows out of the first outlet through the aperture by way of water pressure; and wherein when desiring to flow water out of the second outlet, the controlling post is moved toward the water flow space so that the closing member aligns with the aperture, the closing member is pushed by the water pressure to move toward the aperture, the water stopping portion of the closing member contacts with the aperture, the closing member or the water stopping portion contacts with the first locking portion and the second locking portion, and the water flows out of the second outlet.

5. The switching structure for the faucet as claimed in claim 3, wherein the closing member of the switch valve horizontally moves.

6. The switching structure for the faucet as claimed in claim 3, wherein the closing member of the switch valve swings at a predetermined angle.

7. The switching structure for the faucet as claimed in claim 3, wherein the first locking portion of the switch valve is arranged on the closing member or the water stopping portion, and the second locking portion is formed on the peripheral side of the aperture and in a ring shape, such that the first locking portion fits with an edge, an inner wall or an outer wall of the second locking portion.

8. The switching structure for the faucet as claimed in claim 3, wherein the switch valve includes a fitting sleeve coupled with the holder and fitted on the controlling post and the resilient element.

9. The switching structure for the faucet as claimed in claim 3, wherein the switch valve further includes a button fixed on the controlling post and extending out of one end of the holder.

10. The switching structure for the faucet as claimed in claim 3, wherein the resilient element of the switch valve fits on the controlling post.

11. The switching structure for the faucet as claimed in claim 3, wherein the water stopping portion is separately formed from the closing member and is ring shaped, wherein the closing member is annular in shape; and wherein the first locking portion comprises a disc with a stud projecting axially therefrom, with the stud received in the closing member, and with the water stopping portion sandwiched between the disc and the closing member.

12. The switching structure for the faucet as claimed in claim 11, wherein the second locking portion is annular shaped and located in the aperture, with the second locking portion sandwiched between the first outlet tube and the disc when the closing member is pushed by the water pressure to move toward the aperture.

13. The switching structure for the faucet as claimed in claim 3, wherein the first locking portion has an annular fitting projection, and wherein the second locking portion is ring shaped around the aperture, with the annular guide slideably received in the annular fitting portion when the closing member is pushed by the water pressure to move toward the aperture.

14. The switching structure for the faucet as claimed in claim 13, wherein the water stopping portion is separately formed from the closing member and located within the annular fitting projection.

15. The switching structure for the faucet as claimed in claim 13, wherein the water stopping portion is separately formed from the closing member and is a disc having a dome shape and located within the annular fitting projection.
